(19) United States
(12) Patent Application Publication
(10) Pub. No.: US 2013/0211869 A1
(43) Pub. Date: Aug. 15, 2013

(54) METHOD AND APPARATUS FOR ORGANIZING A CALENDAR IN A COMMUNICATION DEVICE

(71) Applicant: Samsung Electronics Co., Ltd., (US)

(72) Inventor: Rajendra SUBRAMANYAIAH, Bangalore (IN)

(73) Assignee: Samsung Electronics Co., Ltd., Gyeonggi-do (KR)

(21) Appl. No.: 13/762,658

(22) Filed: Feb. 8, 2013

(30) Foreign Application Priority Data
Feb. 10, 2012 (IN) 510/CHE/2012

(51) Int. Cl. G06Q 10/06

(52) U.S. Cl. CPC G06Q 10/06314
USPC 705/7.24

(57) ABSTRACT

An apparatus and method for organizing events in the calendar on a device is disclosed. The method enables a user to create events and send the calendar event to members of his choice. The method generates a unique identification tag and associates the identification tag with the event. The event is then sent. Further, members may respond to the received event or any other event. The device then checks whether the identification tag is associated with the response. If associated, then the response is grouped under the particular event. If the device finds no identification tag associated with the event then it treats the response as a normal message. The method enables a user to view all the information exchanged on a particular event in a calendar for a period of time.

### PRIORITY

This application claims priority under 35 U.S.C. §119(a) to an Indian Patent Application filed in the Indian Patent Office on Feb. 10, 2012 and assigned Serial No. 510/CHE/2012, the entire contents of which is incorporated herein by reference.

### BACKGROUND

1. Field of the Invention

The present invention generally relates to personal information management, and more particularly, to event management in a communication device.

2. Description of the Related Art

In an information centric world, personal information management is important for people to organize several events in the business arena and for personal purposes as well. Whether it is a birthday party or an official presentation, people create the calendar events and send these events to their friends or peers.

When a user organizes an event using a communication device, the user needs to schedule the event. Further, the event is to be sent to people with whom he would want to share the event. On receiving notice of the event, the recipient may respond to the user with a reply or some comments. In some cases, the user may send the created event to one group of people and at the same time the user may want to create another event and send the second event to some other recipients. In such a scenario, if both groups of recipients reply to the respective events, and if the user wants to look at the replies pertinent to the respective events created, the user will have to search for the replies received and filter the responses identified for the appropriate events.

In an example, user X sends a meeting request for a presentation to his team members. After the presentation, each team member sends a query through mail to user X regarding the presentation. In between this communication time, user X receives mails which are not related to the presentation. Further, at the same time, user X also sends a weekly meeting request to his team members and after every weekly meeting, user X sends the minutes of the meeting to all the team members. In this scenario, if user X wants to look at the information exchanged on the subject of his presentation, then user X will have to search through all the responses in his mail box and organize the responses corresponding to the presentation or the weekly meeting. The whole process of searching through the list of messages and sorting them becomes cumbersome and time consuming. As a result, such a process may not be preferred by the user.

Some of the existing methods provide mechanisms to organize events in the calendar. These mechanisms basically allow the user to employ keywords and the like from the event for fetching the related messages. These methods, however, are not effective as at some level they require the user to perform some manual activity. In addition, there is also a possibility of conflicting keywords, and in such a case, there may be a conflict among the event messages. Due to this, the search may pull out some messages that do not correspond to an event of the user's choice. As a result, these methods fail to categorize the respective events and messages related to the events.

From the above, it is evident that existing methods do not have effective methods to organize the information exchanged related to a particular event. Further, these methods involve a lot of manual activity from the user side. As a result, there is a need for a method to improve the process of organizing the information exchanged related to a particular event. The method must be user friendly and intelligent to extract the right information when required.

### SUMMARY

The present invention has been made to address the above problems and disadvantages and to provide at least the advantages described below.

Accordingly, an aspect of the embodiments of the present invention is to provide a means to organize information exchanged related to a particular calendar event.

Another aspect of the embodiments of the present invention is to associate a unique identification tag for every event so as to distinguish each event from other events.

Another aspect of the embodiments of the present invention is to link every message exchanged related to the event with the event ID tag.

According to an aspect of the present invention, a method for identifying information related to an event in a calendar schedule on a device is provided. The method includes providing a unique identification tag for an event created by a user, associating the unique identification tag to messages related to the event sent from the device, checking for the unique identification tag in a second message obtained on the device, and linking the second message to the event on the device.

According to an aspect of the present invention, a device for identifying and organizing information related to an event on a calendar schedule is provided. The device is configured for providing a unique identification tag for an event created by a user, associating the unique identification tag to messages related to the event sent from the device, checking if a received message on the device includes the unique identification tag, and linking the message to the event on the device.

According to an aspect of the present invention, a device with an integrated circuit including at least one processor and at least one memory having a computer program code is provided. The memory and computer program code are configured to, with the at least one processor, cause the device to identify and organize information related to an event on a calendar schedule. The device is configured to provide a unique identification tag for an event created by a user, associate the unique identification tag to messages related to the event sent from the device, checking if a received message on the device includes the unique identification tag, and linking the message to the event on the device.

### BRIEF DESCRIPTION OF FIGURES

The above aspects and features of the present invention will be better understood from the following detailed description, taken in conjunction with the accompanying drawings, throughout which like reference letters indicate corresponding parts in the various figures, in which:

FIG. 1 is a block diagram of a apparatus, according to embodiments of the present invention;

FIG. 2 is a flow chart depicting a method of organizing events, according to embodiments of the present invention;

FIG. 3 is a flow chart depicting sending event information, according to embodiments of the present invention;

FIG. 4 is a flow chart depicting identifying an event at the receiver end, according to embodiments of the present invention;

FIG. 5 is a screen shot illustrating a calendar application on the communication device, according to embodiments of the present invention;

FIG. 6 is a screen shot illustrating an events schedule list, according to embodiments of the present invention;

FIG. 7 is a screen shot illustrating a user selected schedule list, according to embodiments of the present invention;

FIG. 8 is a screen shot illustrating different modes for sending the event information, according to embodiments of the present invention;

FIG. 9 is a screen shot illustrating information exchanged regarding the events, according to embodiments of the present invention; and

FIG. 10 is screen shot illustrating another scenario of information exchange, according to embodiments of the present invention.

### DETAILED DESCRIPTION OF EMBODIMENTS OF THE PRESENT INVENTION

The embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

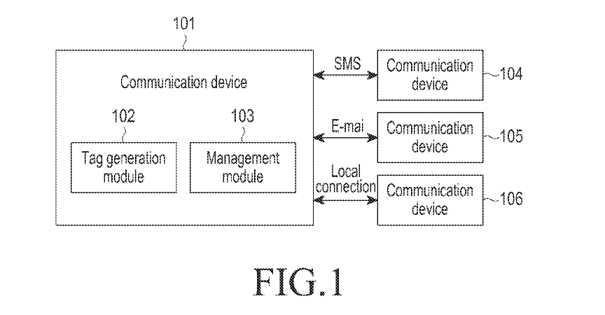

The embodiments herein achieve a method and apparatus to organize all the information related to an event together. The apparatus employs a unique ID to differentiate every event from other events. Referring now to the drawings, and more particularly to FIGS. 1 through 10, where similar reference characters denote corresponding features consistently throughout the figures, there are shown embodiments of the present invention.

A method and apparatus to create an event and organize the information exchanged related to that particular event in a device is disclosed. The device may be a communication device. The method enables the user to create a calendar event and send the event to a group of members with whom he wishes to share the event. The method associates a unique tag with every event created. On obtaining the event request, the members may send comments or a response to the user regarding the event. Further, the method identifies that the response message corresponds to a particular event sent by the user and organizes the response message with the same calendar event. If the user wishes to look at the information exchanged in relation to that event, he can easily see all the information exchanged on a particular event over a period of time. The method thus facilitates a more desirable user experience.

FIG. 1 is a block diagram of the apparatus, according to embodiments of the present invention. A plurality of communication devices 101, 104, 105 and 106 are shown in FIG. 1.

The communication device 101 comprises a tag generation module 102 and a management module 103. The tag generation module 102 is responsible for generating a unique tag for every event created by the user. The tag is uniquely generated by the module by taking into consideration different factors such as time, date, initiator/creator of the event, location, subject, etc.

The management module 103 acts as an intelligent module of the apparatus or the communication device 101. The management module 103 is responsible for managing the responses and associating the generated ID with every response to a particular calendar event. Further, on obtaining a message on the communication device 101, the management module 103 checks for the tag and links the message to the corresponding event.

The user of communication device 101 can create the event and send it to members or recipients having a communication device 104 via SMS (short message service). In one embodiment, user may send the event via e-mail or any other local connectivity method. The recipient or the members may send responses about the event created by the user using the same mode of communication such as SMS, or e-mail or any other local connectivity method using Bluetooth, Infrared, and the like.

The embodiments herein refer to the communication device 101, 104, 105 and 106 as a mobile phone; however, the scope may not be limited to the same and may be extended to any other communication device like a PC, laptop, smart phone and so on.

In an embodiment, the device includes an integrated circuit comprising at least one processor and one memory having a computer program code. The memory and the computer program code may be configured to, with the processor, cause the apparatus to perform the required implementation.

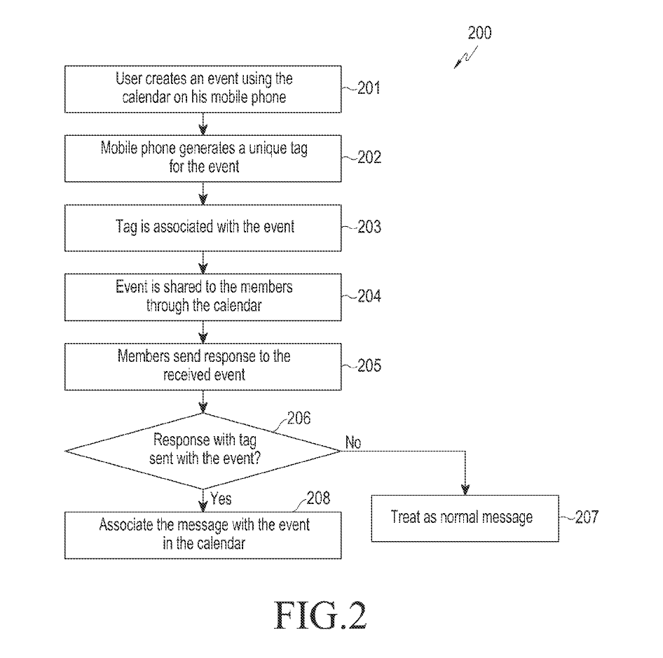

FIG. 2 is a flow chart depicting the method of organizing events, according to embodiments of the present invention. In an embodiment, an example using a mobile phone is considered herein. As depicted in the flow chart, a user employs his mobile phone to create a calendar event of his choice at step 201. For example, the event may be a weekly meeting request or a birthday party invitation, a conference invite, call discussion and the like. Further, the tag generation module 102 residing on the mobile phone generates a unique tag for this event at step 202. This tag is a combination of subject, time, date, user, recipients, venue that identifies the unique calendar event, etc. The mobile phone then associates the tag with the calendar event at step 203. The user shares the event with the members of his choice at step 204. The members, upon receiving the event request, may respond to the event by sending a message to the user at step 205. In one embodiment, the member may also send a comment or response message related to some other event to the user. At the user end, on obtaining the message, the mobile phone checks whether the response message is associated with tag or not at step 206. If not, the apparatus determines that the response message is not associated with the tag and treats the message as a normal message at step 207. On the other hand, if the response is associated with the tag, then the apparatus links the response under the particular event in the calendar at step 208. The various actions in method 200 may be performed in the order presented, in a different order, or simultaneously. Further, in some embodiments, some actions listed in FIG. 2 may be omitted.

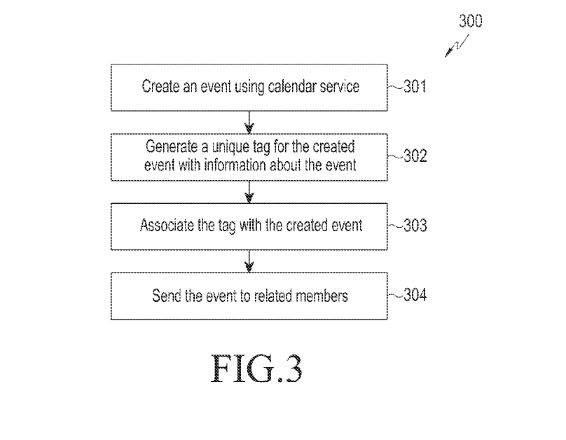

FIG. 3 is a flow chart depicting sending event information, according to embodiments of the present invention. The user creates an event using a calendar service at step 301. Then the communication device creates a unique identifier tag for the event, with some information at step 302. The information in the tag may be a combination of subject/time, date, user, recipients, venue that identifies the unique calendar event, etc. The tag created by the communication device is invisible to the user and to the recipients. The tag is then associated with the particular calendar event at step 303. Further, the user may be provided an option to send the calendar event to the members at step 304. The various actions in method 300 may be performed in the order presented, in a different order, or simultaneously. Further, in some embodiments, some actions listed in FIG. 3 may be omitted.

In one embodiment, the calendar event may be an event for training and the presenter sends the calendar event to all the attendees of the training session. A tag will be created by the communication device along with the calendar event and sent to the attendees.

The recipients or the members upon receiving the calendar event may send some comments or responses about the event, and the invisible tag will also be accompanied with the response.

In one embodiment, the recipient may also send a message or response related to some other event. In such a case, the communication device will identify the message with the tag and the message without the tag and associate the message to the events in the calendar. In one embodiment, the user sends the presentation event to the members and the apparatus generates a unique tag for the event and associates the tag with the event. Members can send some response on the presentation which is associated with the same tag, while other members can send responses related to some other events. The communication device is provided with intelligent technology to identify which response corresponds to which event, and associates them appropriately.

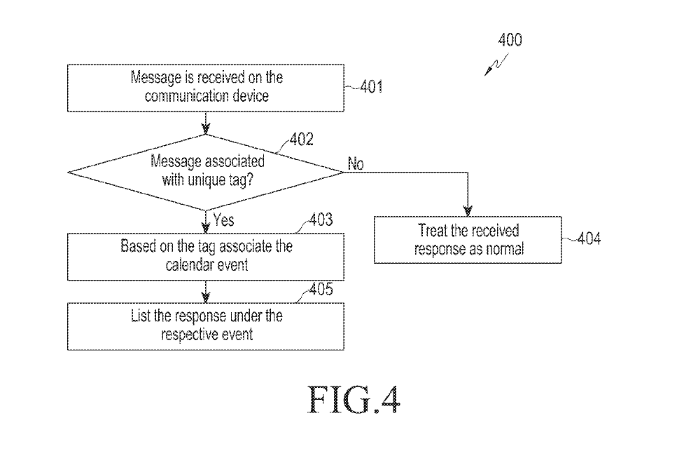

FIG. 4 is a flow chart depicting identifying an event at the receiver end, according to embodiments of the present invention. The communication device receives a response message from the recipients at step 401. Further, the communication device checks for the unique tag associated with the response message at step 402. If the unique tag received matches with the tag sent associated with the event created by the user then the communication device identifies that the received information belongs to the event at step 403. Then the information is grouped or linked under related calendar event. On the other hand, if the received message does not contain a tag along with it then the communication device treats the message as a normal message at step 404. After identifying the response the communication device lists the information with the relative calendar event at step 405. The communication device then organizes all the information exchanged about a particular event in the calendar. The various actions in method 400 may be performed in the order presented, in a different order, or simultaneously. Further, in some embodiments, some actions listed in FIG. 4 may be omitted.

In one embodiment, the event created by the user may be generic events such as planning a movie night, hosting a dinner party, summer vacation with friends, an invitation for engagement, and so on. The response from the recipients may include suggestions from people, final notes exchanged after the event, and so on.

In another embodiment, the event may be related to a weekly status meeting, and the minutes of the meeting information of each week are listed together along with the event. In the case of an event related to a weekly report, the apparatus lists all the reports sent/received together along with the event.

In yet another embodiment, when an event is related to a training/presentation, then the apparatus lists all the feedback or queries received or sent together along with the event.

In yet another embodiment, when an event is related to a review, then the apparatus organizes reviewers received or sent together along with the event.

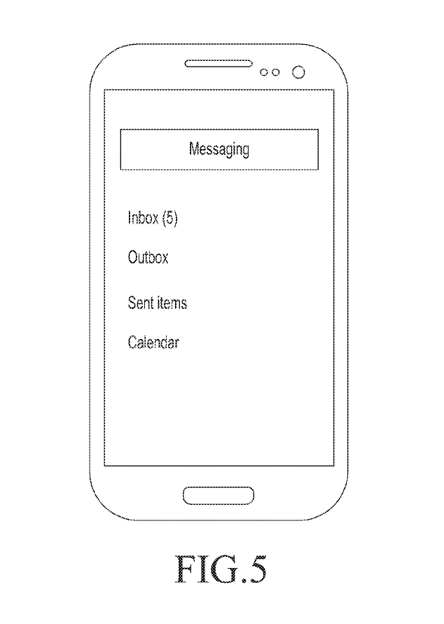

FIG. 5 is a screen shot illustrating the calendar application on a communication device, according to embodiments of the present invention. The communication device illustrated here has a user interface that displays several entities. The interface displays inbox messages received, outbox messages, sent items and calendar events. The user may click on the calendar to organize or see all the events in the calendar.

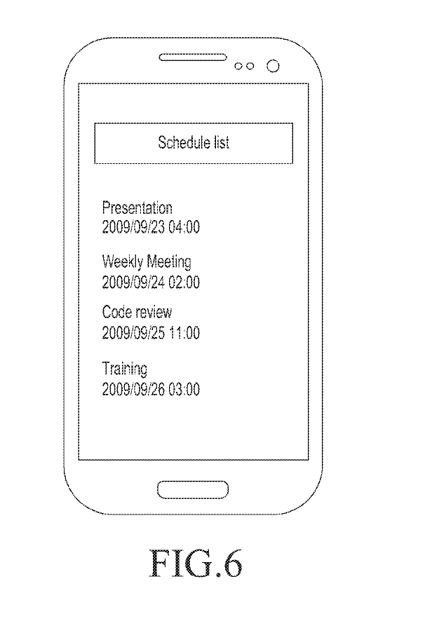

FIG. 6 is a screen shot illustrating an events schedule list, according to embodiments of the present invention. When the user clicks on the calendar, the communication device provides the schedule list. The list indicates the events stored in the calendar. The user may select any of the events and send the event to the members with whom he wishes to share. In one embodiment, the communication device displays the schedule list related to the presentation, meeting, code review and training. The events are associated with a date and time. The user may select any event and send the event to the members.

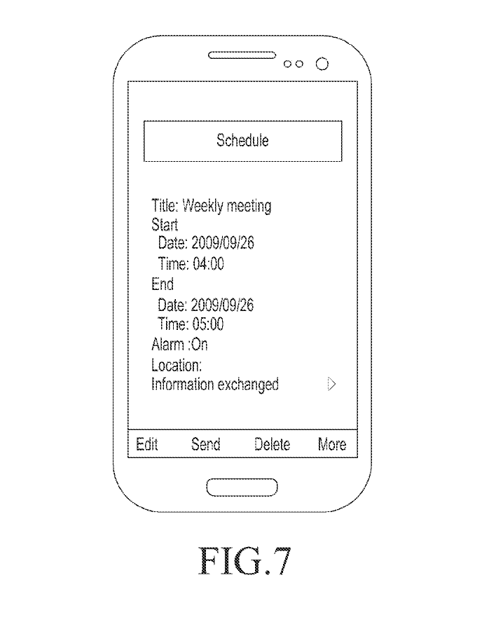

FIG. 7 is a screen shot illustrating a user selected schedule list, according to embodiments of the present invention. The user selects the weekly meeting event in the calendar list. All the details pertinent to the weekly meeting are displayed to the user. The details may include, and are not limited to, date, start and end time of the event, location, and alarm status. In one embodiment, the calendar event is sent with the alarm, which prompts the member about the event. In another embodiment, the user is provided options on the communication device to edit the event, send the event, delete the event, and so on.

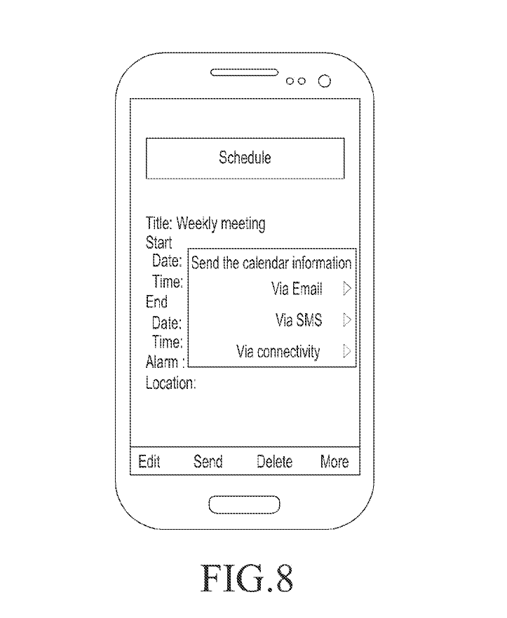

FIG. 8 is a screen shot illustrating different modes for sending the event information, according to embodiments of the present invention. The user selects the send option on the display to send the event to respective members. The user may send the calendar event via SMS (Short Message Service), via an e-mail, or via any of the local connectivity means such as Bluetooth, Infrared and so on. When the send is activated for the event, a unique tag will be associated with the event. The tag is created by the communication device with some information about the event. In one embodiment, the information in the tag includes the combination of time, date, initiator, location, subject, and so on. The event associated with a communication device generated tag is sent to the members via any of the aforementioned communication modes.

In one embodiment, the tag may be encoded in a way to identify the subtype of each event. The subtype may be the subject of the event.

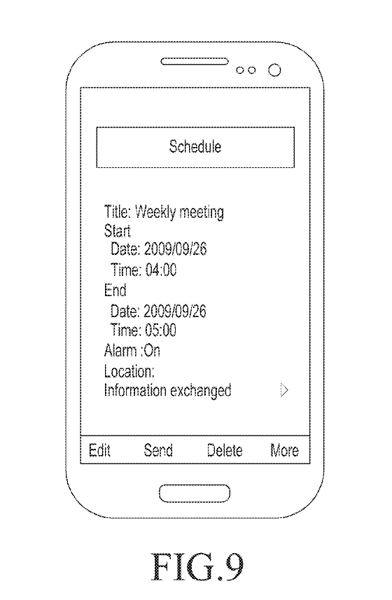

FIG. 9 is a screen shot illustrating information exchanged regarding the events, according to embodiments of the present invention. The user with the communication device sends the event to the members and receives a response from the members. Further, the communication device checks whether the received response is associated with the tag or not. Based on this, the response is associated with the particular calendar event. On the communication device, there is an option for the user to view the information exchanged about a particular event. When the user selects the information exchange option, the communication device displays all the information exchanged about an event in a period of time.

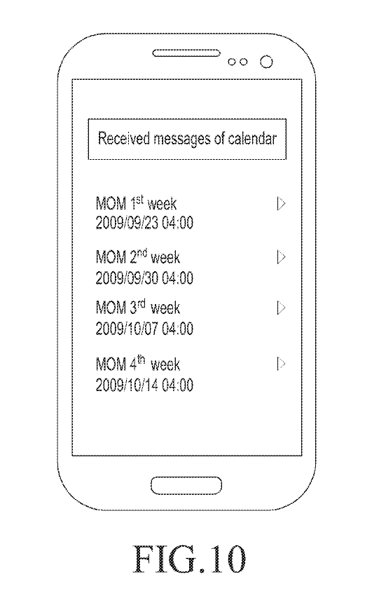

FIG. 10 is screen shot illustrating another scenario of information exchange, according to embodiments of the present invention. In one embodiment, the user with a communication device selects the information exchanged on a weekly meeting calendar event, the apparatus will display all the minutes of the meeting received for a period of time to the user. In another embodiment, the event may be a birthday or anniversary and the response may be the greetings, gifts and so on. When the user selects the information exchanged on the birthday or anniversary event, he will see all the greetings, gifts received, etc. In one embodiment, after sending the event to the members, the user may choose to delete the event from the communication device and the responses sent from members about the deleted event. In this scenario, the communication device treats the response as a normal message as there is no tag associated with the message.

In one embodiment, the user may track the information about a calendar event from the inbox. The apparatus provides a User Interface link from the inbox so that user can track the calendar event.

In one embodiment, the apparatus allows the user to forward, upload or take backup of all related-information of a calendar event, by simply clicking a simple menu option on the communication device.

In one embodiment, the responses received from the members may be via SMS, e-mail, or any local connectivity means such as Bluetooth, Infrared and so on.

The embodiments disclosed herein may be performed by a standalone integrated circuit or an integrated circuit present within the device as described herein, where the integrated circuit includes at least one processor and one memory element. The integrated circuit may be a Digital integrated circuit, an analog integrated circuit or a combination of analog and digital integrated circuits and made available in a suitable packaging means.

The embodiments disclosed herein can be implemented through at least one software program running on at least one hardware device and performing network management functions to control the elements. The elements shown in FIG. 1 include blocks which can be at least one of a hardware device, or a combination of a hardware device and software.

The foregoing description of the specific embodiments so fully reveals the general nature of the embodiments herein that others can, by applying current knowledge, readily modify and/or adapt for various applications such specific embodiments without departing from the spirit and scope of the present invention. Therefore, such adaptations and modifications should and are intended to be comprehended within the meaning and range of equivalents of the disclosed embodiments. It is to be understood that the phraseology or terminology employed herein is for the purpose of description and not of limitation. Therefore, while the present invention has been described in terms of certain embodiments, those skilled in the art will recognize that the embodiments can be practiced with modification within the spirit and scope of the embodiments as described herein.

What is claimed:

1. A method for identifying information related to an event in a calendar schedule on a device, the method comprising:
generating a unique identification tag for an event;
associating the unique identification tag to messages related to the event;
checking for the unique identification tag in a second message obtained on the device; and
linking the second message to the event on the device.

2. The method as claimed in claim 1, wherein the unique identification tag includes at least one of date, time, location, creator of the event, subject, recipients and venue.

3. The method as claimed in claim 1, wherein associating the unique identification tag to messages comprises identifying a message related to the event on the device and attaching the unique identification tag to the message.

4. The method as claimed in claim 1, wherein the second message is a response obtained from a second device for the event.

5. The method as claimed in claim 1, further comprising providing a link for each event where a user can access the messages related to the event.

6. The method as claimed in claim 1, wherein the device includes at least one of a mobile phone, a smart phone, a laptop and a desktop.

7. The method as claimed in claim 1, wherein the message is at least one of an SMS, an MMS and an email.

8. A device for identifying and organizing information related to an event on a calendar schedule, wherein the device is configured for:
providing a unique identification tag for an event;
associating the unique identification tag to messages related to the event;
checking if a received message on the device includes the unique identification tag; and
linking the message to the event on the device when the received message on the device includes the unique identification tag.

9. The device as claimed in claim 8, wherein the tag includes a combination of at least one of date, time, location, creator of the event, subject, recipients and venue.

10. The device as claimed in claim 8, wherein the device is further configured for identifying a message related to the event on the device and attaching the unique identification tag to the message.

11. The device as claimed in claim 8, wherein the message is a response obtained from a second device for the event.

12. The device as claimed in claim 8, wherein linking the message to the event allows a user to access messages related to the event.

13. The device as claimed in claim 8, wherein the device is at least one of a mobile phone, a smart phone, a laptop, and a desktop.

14. The device as claimed in claim 8, wherein the message is at least one of an SMS, an MMS, and an email.

15. A device for identifying and organizing information related to an event on a calendar schedule, the device comprising:
an integrated circuit comprising at least one processor; and
at least one memory having a computer program code,
the at least one memory and the computer program code configured to, with the at least one processor, cause the device to:
generate a unique identification tag for an event;
associate the unique identification tag to messages related to the event;
check if a received message on the device includes the unique identification tag; and
link the message to the event on the device when the received message on the device includes the unique identification tag.

16. The device as claimed in claim 15, wherein the tag includes a combination of at least one of date, time, location, creator of the event, subject, recipients and venue.

17. The device as claimed in claim 15, wherein the at least one memory and the computer program code are further configured to cause the device to identify a message related to the event on the device and attach the unique identification tag to the message.

18. The device as claimed in claim 15, wherein the message is a response obtained from a second device for the event.

19. The device as claimed in claim 15, wherein the at least one memory and the computer program code are further configured to cause the device to provide a link for each event where a user can access the messages related to the event.

20. The device as claimed in claim 15, wherein the device is at least one of a mobile phone, a smart phone, a laptop, and a desktop.

21. The device as claimed in claim 15, wherein the message is at least one of an SMS, an MMS and an email.
